(19) United States
(12) Patent Application Publication
(10) Pub. No.: US 2020/0189982 A1
(43) Pub. Date: Jun. 18, 2020

(54) FIREPROOF MOLDING BODY AND METHOD FOR PRODUCING THE SAME

(71) Applicant: Siemens Aktiengesellschaft, Munich (DE)

(72) Inventors: Tobias Buchal, Dusseldorf (DE); Elke Henschel, Mulheim an der Ruhr (DE); Simon Kliesch, Haan (DE); Christian Nikasch, Mulheim an der Ruhr (DE); Uwe Paul, Ratingen (DE); Kang Qian, Mulheim an der Ruhr (DE); Alexander Schaufler, Essen (DE); Martin Wilke, Essen (DE)

(73) Assignee: Siemens Aktiengesellschaft, Munich (DE)

(21) Appl. No.: 16/472,867

(22) PCT Filed: Nov. 7, 2017
(86) PCT No.: PCT/EP2017/078422

§ 371 Date: Jun. 22, 2019

(30) Foreign Application Priority Data
Jan. 25, 2017 (DE) 10 2017 201 185.8

(51) Int. Cl. C04B 35/657; C04B 35/101

(52) U.S. Cl. CPC C04B 35/657; C04B 35/66; C04B 35/101

(57) ABSTRACT

A fireproof molding body having a hot side and a cold side opposite said hot side, wherein the fireproof molding body includes a first material with ceramic hollow sphere structures, wherein an amount of hollow sphere structures decreases from the hot side to the cold side. A method for producing a fireproof molding body in which a first material with ceramic hollow sphere structures is introduced into a casting mold and a grading of the hollow sphere structures is subsequently performed.

### CROSS REFERENCE TO RELATED APPLICATIONS

This application is the US National Stage of International Application No. PCT/EP2017/078422 filed Nov. 7, 2017, and claims the benefit thereof. The International Application claims the benefit of German Application No. DE 10 2017 201 185.8 filed Jan. 25, 2017. All of the applications are incorporated by reference herein in their entirety.

### FIELD OF INVENTION

The invention relates to a refractory molding and to a method for its production.

### BACKGROUND OF INVENTION

Refractory moldings, such as for example ceramic heat shields, can be used as thermal barriers in combustion chambers. In such cases, heat shields are subjected to high thermo-mechanical, chemical and erosive stresses. Usually, ceramic heat shields are produced by the slip casting process and then sintered. In addition, they may be given a ceramic protective coating, in order to prevent corrosion (for example of mullite components in the heat shield).

On account of temperature gradients in the ceramic heat shield, this layer often delaminates even after a short time during the operation of the gas turbine. Without the layer, increased hot gas corrosion and subsequent erosion occur on the ceramic heat shield. The particles thereby detached are accelerated in the direction of the turbine, where they can lead to damage to the coating systems of the turbine blades, especially to the coating systems. In particular, the detached particles of the ceramic heat shields of a size of over 1 mm in this case lead to damage of the turbine blade thermal barrier coating (TBC). Typically, the grain size of the particles that are used in the prior art is up to 3 mm, but may even be greater. These particle sizes are necessary to impart the required thermal shock resistance to the ceramic material.

### SUMMARY OF INVENTION

An object of the invention is to provide a refractory molding which is improved in comparison with the prior art and has an increased lifetime and reduced potential for damage to downstream components, and which at the same time can be produced as easily and inexpensively as possible.

This object is achieved in the case of a refractory molding with a hot side and a cold side opposite from the hot side in that the refractory molding comprises a first material with ceramic hollow sphere structures, an amount of hollow sphere structures decreasing from the hot side to the cold side.

The main damage to the thermal protective layers of the turbine blades is caused by the comparatively larger particles that can become detached from the ceramic heat shield during the operation of the system. They may be for example sintered corundum with diameters of between 1 mm and 3 mm. From the viewpoint of protecting the turbine blade coating, it is therefore desirable to use corundum particles that are as small as possible, or if this is not possible, for example for reasons of thermal shock resistance, as light as possible. Consequently, after possible detachment of these particles from the surface of the ceramic heat shields and transport in the gas stream, the impulsive force when they strike the thermal coating of the downstream turbine blades is likewise reduced and the risk of damage to the coating is lessened.

The use of ceramic hollow sphere structures as at least a partial replacement for the previously used, for example larger, particles of the sintered structures brings about a clear improvement here, since hollow sphere structures have a lower density than comparatively large conventional particles in the sintered structures. If a particle or part of a particle with a hollow sphere structure becomes detached from the ceramic heat shield, it strikes the turbine blade surface with less impact (less weight, less energy, less impulsive force, plastification of the hollow structure particles) and therefore either causes no damage or at least causes less damage to the thermal protective layer thereof than a solid ceramic particle of a comparable size.

In an advantageous embodiment of the invention, a refractory molding consists of a first material with ceramic hollow sphere structures. Compared with the use of a number of materials, this brings about the advantage in the production process that indeed only a single material has to be processed. However, suitable measures then have to be taken to ensure the grading within the molding.

In an alternative embodiment of the invention, the refractory molding comprises in addition to the first material with ceramic hollow sphere structures a second material with sintered structures, the first material and the second material differing in that a sintered raw material of one particle size in the second material is replaced in the first material by a raw material with hollow sphere structures of the same particle size and the same particle size distribution. As a result, the grain size distribution in the refractory molding is unchanged.

For this reason, it is expedient if the other raw materials of the first and second materials are the same. As a result, the differences with respect to the constitution in the materials used is minimal.

In a further advantageous embodiment, the hollow sphere structures are at least partially broken before casting to form the refractory molding. This is performed deliberately and has the effect that the partially broken hollow sphere particles provide better points of attachment (for example better interlocking) for the surrounding matrix of the refractory molding, that is to say of the ceramic heat shield, and consequently an improved microstructural attachment in comparison with spherical hollow sphere structures. This brings about a better structural strength when there are increased temperatures and/or temperature gradients.

It is advantageous if the hollow sphere structures comprise hollow corundum spheres. It is also advantageous if the sintered structures comprise sintered corundum. This aluminum oxide is very temperature- and corrosion-resistant and has good wear characteristics.

It is therefore expedient in this connection if this material is present in the refractory molding in an appreciable proportion; in particular, it is advantageous if the proportion by weight of sintered corundum in the second material exceeds 30% of the solid constituents of the second material.

The object directed at a method is achieved by a method for producing a refractory molding in which a first material with ceramic hollow sphere structures is introduced into a casting mold and a grading of the hollow sphere structures is subsequently performed. This grading, proposed by this invention, can be made possible by making use of the fact that the hollow sphere structures tend to be lighter, and consequently have a propensity to float in a slip system.

However, this does not take place as a matter of course. It is therefore expedient if the grading of the hollow sphere structures is performed by vibration, to be precise at specific frequencies and over suitable times.

If the refractory molding is a heat shield element with a hot side and a cold side opposite from the hot side, it is also expedient if the first material is introduced in the region of the hot side, i.e. the heat shield element is produced horizontally, so that the hollow corundum spheres can in principle float toward the hot gas side, whereby the heavier particles sink toward the cold gas side of the ceramic heat shield. This achieves a desired gradient in the ceramic heat shield, which the hollow corundum spheres with the better insulation and thermal shock stability on the hot gas side and the finer and more resistant particles on the cold gas side of the ceramic heat shield enhance. In the case of such a method, however, the sprue on the upper side of the cast part, i.e. on the hot side of the heat shield element, would have to be removed by working.

In an alternative method for producing a refractory molding, a casting mold is divided into two chambers by a retractable blade (parting surface) and a first material with hollow sphere structures and a second material without hollow sphere structures are introduced separately into one each of the chambers and the blade is subsequently retracted. This makes use of the comparatively high basic viscosity of the materials, which after removal of the blade remain in their respectively intended position, and only interlock with one another as desired.

### BRIEF DESCRIPTION OF THE DRAWINGS

The invention is explained in more detail by way of example on the basis of the drawings, in which schematically and not to scale:

FIG. 1 shows a refractory molding according to the invention in a schematic representation,

FIG. 2 shows a casting mold for the production of the refractory molding according to the invention,

FIG. 3 shows a further casting mold for the production of the refractory molding according to the invention and

FIG. 4 shows a flow diagram for the inventive method for producing a refractory molding.

### DETAILED DESCRIPTION OF INVENTION

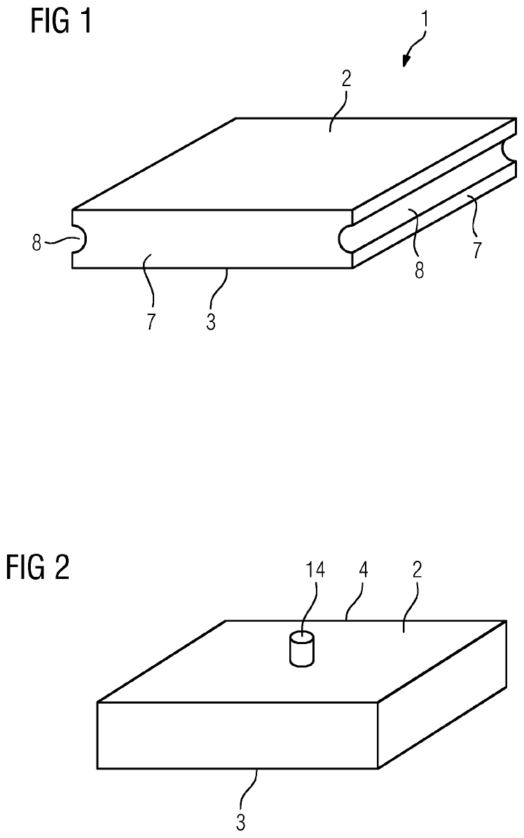

FIG. 1 shows schematically by way of example a heat shield element for a gas turbine combustion chamber as an exemplary embodiment of a refractory molding 1 according to the invention. The heat shield element 1 represented in FIG. 1 has a hot side 2, which is intended to face the interior of a combustion chamber, and a cold side 3, which is opposite from the hot side 2 and is intended to face the supporting structure of the combustion chamber, and also four circumferential sides 7, which connect the hot side 2 to the cold side 3. In two of the circumferential sides 7 there are grooves 8, which allow the engagement of a holding clip holding the heat shield element 1 on the supporting structure. Other holding possibilities, with which the grooves 8 are not necessary, may of course also be used. For example, the cold side 3 of the heat shield element 1 may be screwed to the supporting structure.

FIG. 2 shows a casting mold 4 for the production of the refractory molding 1 according to the invention by the method according to the invention, in which a first material with ceramic hollow sphere structures is introduced into the casting mold 4 and a grading of the hollow sphere structures is subsequently performed. The introduction of the first material is in this case performed on the hot side 2 of the refractory molding 1.

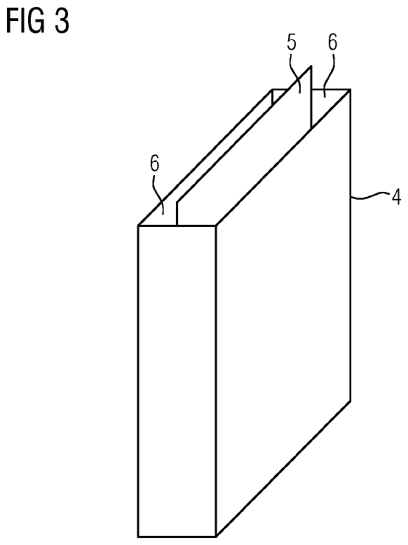

In FIG. 3, the casting mold 4 is divided into two chambers 6 by a retractable blade 5 in such a way that different materials for the hot side 2 and the cold side 3 of the refractory molding 1 can be introduced (for example poured).

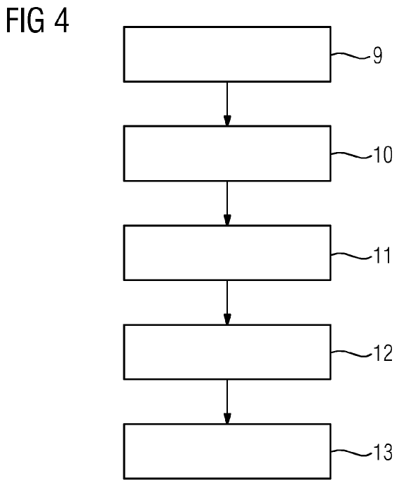

A method for producing the heat shield element represented in FIG. 1 is shown in a schematic flow diagram and described on the basis of FIG. 4. At the beginning of the method, a first material, which comprises hollow sphere structures, is provided (step 9).

Various molding processes come into consideration. According to the invention, a casting mold, which has an opening 14 on the later hot side of the refractory molding, this opening 14 facing upward during casting, is provided (step 10).

The first material is introduced into this opening 14 (step 11).

The grading in the first material is set by vibration (step 12).

Subsequently, the refractory molding 1 is sintered (at temperatures preferably above 1550° C.) (step 13).

Alternatively, a casting mold 4 may be provided and divided into two chambers 6 by a blade 5. Then, the first material with hollow sphere structures and the second material without hollow sphere structures are introduced separately into one each of the chambers 6. Finally, the blade 5 is retracted and after that the refractory molding 1 is sintered, as already described.

1. A refractory molding comprising:
a hot side and a cold side opposite from the hot side, and
a first material comprising ceramic hollow sphere structures, wherein an amount of hollow sphere structures are decreasing from the hot side to the cold side.

2. The refractory molding as claimed in claim 1,
wherein the refractory molding consists of a material with ceramic hollow sphere structures.

3. The refractory molding as claimed in claim 1, further comprising:
in addition to the first material with ceramic hollow sphere structures, a second material with sintered structures, the first material and the second material differing in that a sintered raw material of one particle size in the second material is replaced in the first material by a raw material with hollow sphere structures of the same particle size and the same particle size distribution.

4. The refractory molding as claimed in claim 3,
wherein the other raw materials of the first and second materials are the same.

5. The refractory molding as claimed in claim 1,
wherein the hollow sphere structures are at least partially broken before casting to form the refractory molding.

6. The refractory molding as claimed in claim 1,
wherein the hollow sphere structures comprise hollow corundum spheres.

7. The refractory molding as claimed in claim 3,
wherein the sintered structures comprise sintered corundum.

8. The refractory molding as claimed in claim 7,
wherein a proportion by weight of sintered corundum in the second material exceeds 30% by weight of solid constituents of the second material.

9. A method for producing a refractory molding, comprising:
introducing a first material with ceramic hollow sphere structures into a casting mold, and
subsequently performing a grading of the hollow sphere structures.

10. The method as claimed in claim 9,
wherein the grading of the hollow sphere structures is performed by vibration.

11. The method as claimed in claim 9,
wherein the refractory molding is a heat shield element with a hot side and a cold side opposite from the hot side, and
wherein the first material is introduced in a region of the hot side.
